(19) United States
(12) Patent Application Publication
(10) Pub. No.: US 2023/0051119 A1
(43) Pub. Date: Feb. 16, 2023

(54) Side Mounted Golf Bag Rack

(71) Applicant: Cole A. Broadwell, Carrington, ND (US)

(72) Inventor: Cole A. Broadwell, Carrington, ND (US)

(21) Appl. No.: 17/400,740

(22) Filed: Aug. 12, 2021

(51) Int. Cl. A63B 55/60

(52) U.S. Cl. CPC A63B 55/61

(57) ABSTRACT

A side mounted golf bag rack for holding one or more golf bags at the rear of a golf cart, and to the side to allow rear access. The rack comprises a golf bag rack having a frame with a lower frame member and an upper frame member, mountable on a side of the golf cart. The rack also includes a cross piece mounted on the upper frame member, the cross piece adapted to secure an upper portion of a golf bag. The rack also includes a lower support member pivotally mounted on the frame, and adapted to support the golf bag in a position adjacent to the side of the golf cart when the lower support member is in a first position; and pivotable to a position along the upper frame member in the second position.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The described example embodiments in general relate to a side mounted golf bag rack for use with a golf cart.

Racks for holding golf bags, mounted on motorized golf carts, have been in use for many years, and are typically mounted on the back of golf carts, and are designed and sized to hold just two golf bags. Since these mount on the rear of the cart, they leave the back unusable for carrying additional passengers, gear, etc. For example, a second, rear-facing seat cannot be accessed if the bags are being carried, because the bags block the seat. Some existing racks are designed to carry a single bag, which is an obvious disadvantage when the cart is used by two golfers, and the single bag and its rack still limits access to the rear of the cart.

### SUMMARY

Some of the various embodiments of the present disclosure relate to a side mounted golf bag rack or holder for use with a golf cart, which can hold golf bags at the rear, side position of the golf cart. In some embodiments, the golf bag rack may include a frame comprising a lower frame member and an upper frame member, wherein the frame is mountable on a side of the golf cart. The rack may also include a cross piece mounted on the upper frame member, the cross piece adapted to secure an upper portion of a golf bag in the rack. The rack further includes a lower support member that can be pivotally mounted on the frame, wherein the lower support member is pivotable between a first position and a second position.

The lower support member is adapted to support the golf bag in a position adjacent to the side of the golf cart when the lower support member is in the first position. The lower support member can be folded out of the way when not in use, and thus can be oriented along the upper frame member in the second position. In some example embodiments, the lower support member rests on a portion of the lower frame member when the lower support member is in the first position, wherein the lower frame member supports the lower support member by limiting its rotation.

In some example embodiments of the golf bag rack the lower frame member is mountable on the golf cart by a transverse mount attachable to the golf cart, such as on the lower frame of the golf cart. The golf bag rack is adapted to hold two golf bags, and the lower support member is adapted to support two golf bags. Two such racks may be mounted on a golf cart—for example, one on each side of the golf cart.

In some other embodiments, the present disclosure comprises a golf bag holding system. The system may have a transverse mount adapted for mounting on the golf cart, and can further include two golf bag racks, each rack attached to the transverse mount at an opposite end of the transverse mount (i.e., one on each side of the golf cart). Each golf bag rack may include a frame comprising a lower frame member and an upper frame member, wherein the frame is attached to the transverse mount. Each rack may also include a cross piece mounted on the upper frame member, the cross piece adapted to secure an upper portion of one or two golf bags. A lower support member of each rack may be pivotally mounted on the frame, wherein the lower support member is pivotable between a first position and a second position, as described above.

There has thus been outlined, rather broadly, some of the embodiments of the present disclosure in order that the detailed description thereof may be better understood, and in order that the present contribution to the art may be better appreciated. There are additional embodiments of that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a perspective view of a side mounted golf bag rack system in accordance with an example embodiment.

FIG. 2 is a rear perspective view of a side mounted golf bag rack system in accordance with an example embodiment.

FIG. 3 is a perspective detail view of a side mounted golf bag rack in accordance with an example embodiment.

FIG. 4 is a rear view of a side mounted golf bag rack in accordance with an example embodiment.

FIG. 5 is a rear view of a side mounted golf bag rack in accordance with an example embodiment.

FIG. 6 is another rear perspective view of a side mounted golf bag rack system in accordance with an example embodiment.

FIG. 7 is another rear perspective view of a side mounted golf bag rack system in accordance with an example embodiment.

FIG. 8 is a perspective detail view of a side mounted golf bag rack showing the rack folded up, in accordance with an example embodiment.

FIG. 9 is a lower perspective detail view of a side mounted golf bag rack showing the rack folded up, in accordance with an example embodiment.

FIG. 10 is another perspective detail view of a side mounted golf bag rack showing the rack in a horizontal position, in accordance with an example embodiment.

FIG. 11 is a partially exploded rear perspective view of a side mounted golf bag rack system in accordance with an example embodiment.

### DETAILED DESCRIPTION

### A. Overview.

Some of the various embodiments of the present disclosure relate to a golf bag holding rack or system that can hold one, two, or more golf bags at the rear, side position of a golf cart 10. Some of the various embodiments of the present disclosure include two golf bag racks 20, each rack having a frame 23 comprising a lower frame member 22 and an upper frame member 24, wherein the frame is mountable on a side of the golf cart 10. The rack 20 may also include a cross piece 26 mounted on the upper frame member 24, the cross piece 26 adapted to secure an upper portion of a golf bag 50 in the rack 20. The rack 20 further includes a lower support member 30 that can be pivotally mounted on the frame 23, for example, on upper frame member 24, wherein the lower support member 30 is pivotable between a first position and a second position.

The pivotal connection of the lower support member 30 to the frame 23 may comprise a hinge that uses a bolt 33 as a pivot member that passes through a bracket on the upper frame member 24 and hinge 32 on the lower support member 30.

The lower support member 30 may comprise a basket, having a substantially flat portion that is sized and shaped to support one or more golf bags 50. The lower support member 30 may be made of various materials using different manufacturing techniques. In one example, the lower support member 30 may comprise an expanded metal support surface 34 (which may comprise the substantially flat portion), angled metal side pieces, and a support tube 35, designed to rest against lower frame member 22 when in the first position. Together, these components provide a rigid assembly. In addition to a metal assembly, the lower support member 30, as well as all parts or components of the system, can be made of other materials, such as composites, plastics, resins, steel, aluminum, or other metals or alloys.

The lower support member 30 is substantially horizontal in the first position, and substantially vertical in the second position. When it is substantially horizontal, it is well suited to support one, two, or more golf bags 50. When it is not in use, the lower support member 30 can be folded up and out of the way in a substantially vertical position. As stated above, the lower support member 30 can be held in the first position due to the support tube 35 resting against a part of lower frame member 22, such as support surface 27, which prevents rotation about hinge 32 beyond the horizontal position. In the second position, in which the lower support member 30 is substantially vertical, the lower support member 30 is held in position by lock 40, which may be comprised of bracket 44 and a locking member, such as a bolt or pin 42 that fits through the bracket 44 and a hole 39 in the frame or a part of lower support member 30.

The lower support member 30 is adapted to support one or more golf bags 50 in a position adjacent to the side 12, 14 of the golf cart 10 when the lower support member 30 is in the first position. The lower support member 30 can be folded out of the way when not in use, and thus can be oriented along the upper frame member 24 in the second position. In some example embodiments, the lower support member 30 rests on a support surface 27 of the lower frame member 22 when the lower support member 30 is in the first position, wherein the lower frame member 22 supports the lower support member 30 by limiting its rotation.

As stated, the example embodiments may comprise a system, wherein more than one golf bag rack 20 is mounted on a single golf cart 10. For example, the system may comprise two golf bag racks 20, each mounted on the side of the golf cart 10 near the rear of the cart, although other locations are possible. In some example embodiments, the lower frame member 22 of each golf bag rack 20 is attached to or mounted on a transverse mount 21, which may be a square tube secured to the bottom portion of golf cart 10.

The transverse mount may be welded or attached to a portion of the frame of golf cart 10 by bolts, adhesives, or other fastening or attachment means. Similarly, each golf bag rack 20 may be welded to the transverse mount 21 or they may be attached with fasteners, bolts, or other means. In an example embodiment, the lower frame member 22 may comprise a square, round, or rectangular tube that fits inside or outside of the transverse mount 21, and can then be welded or bolted in place. A close fit between the lower frame member 22 and the transverse mount 21 adds rigidity to the system.

Each golf bag rack 20 may comprise a cross piece 26, as briefly mentioned above. The cross piece 26 is configured to secure the top portion of one or more golf bags 50. To that end, each cross piece may have a strap 28, such as a nylon web strap, and a buckle 29 to secure the strap once it has been wrapped around a golf bag 50.

### B. Frame.

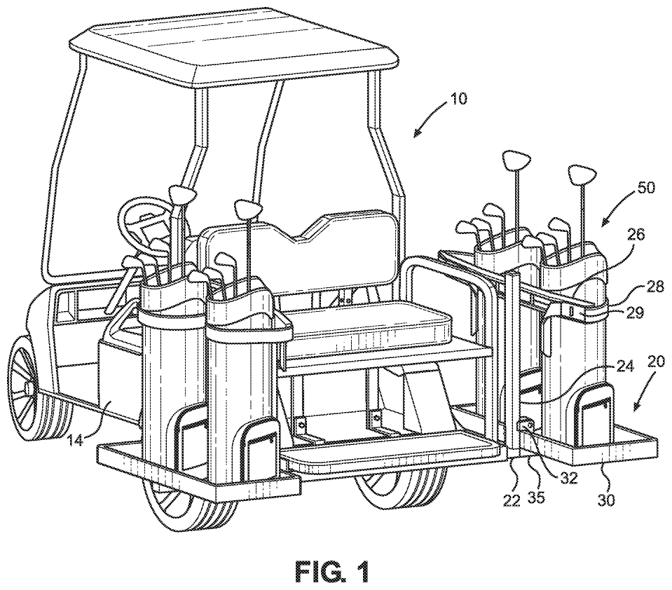

As shown throughout the figures, each golf bag rack 20 may comprise a frame 23 comprising a lower frame member 22 and an upper frame member 24, wherein the frame 23 is removably or permanently mountable on a side of the golf cart 10. The lower frame member 22 and the upper frame member 24 may be made of square, rectangular, or round steel tubes, although other shapes and materials are possible as well. The lower frame member 22 may be attached to a transverse mount 21 that is securely mounted on the golf cart 10. In some embodiments, the frame members 22, 24 may be welded or bolted together, to form an L-shaped frame 23 as shown for example in FIGS. 1-9. To add strength and rigidity, the upper frame member 24 may be bolted, welded, or otherwise attached to the frame of golf cart 10, such as a rail of the golf cart, at a location above and spaced apart from lower frame member 22.

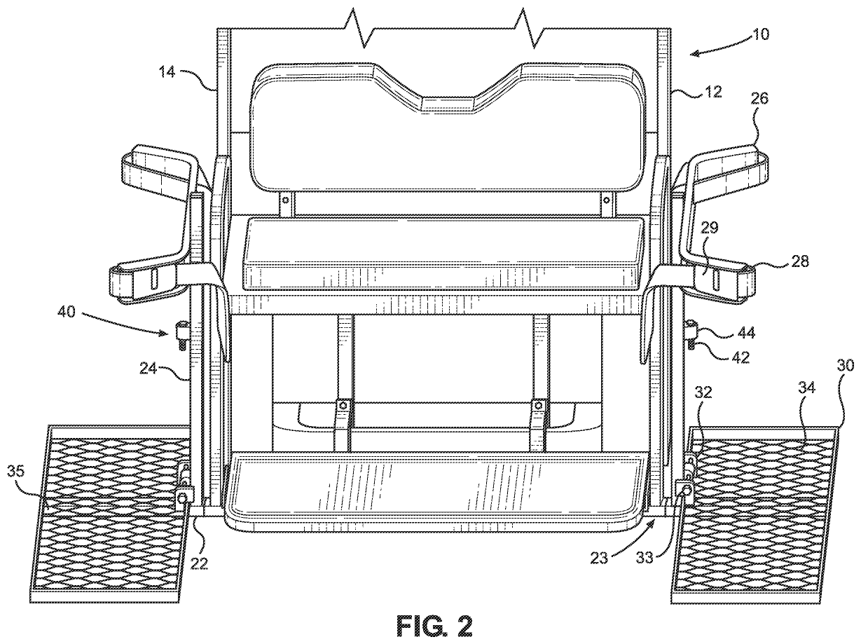

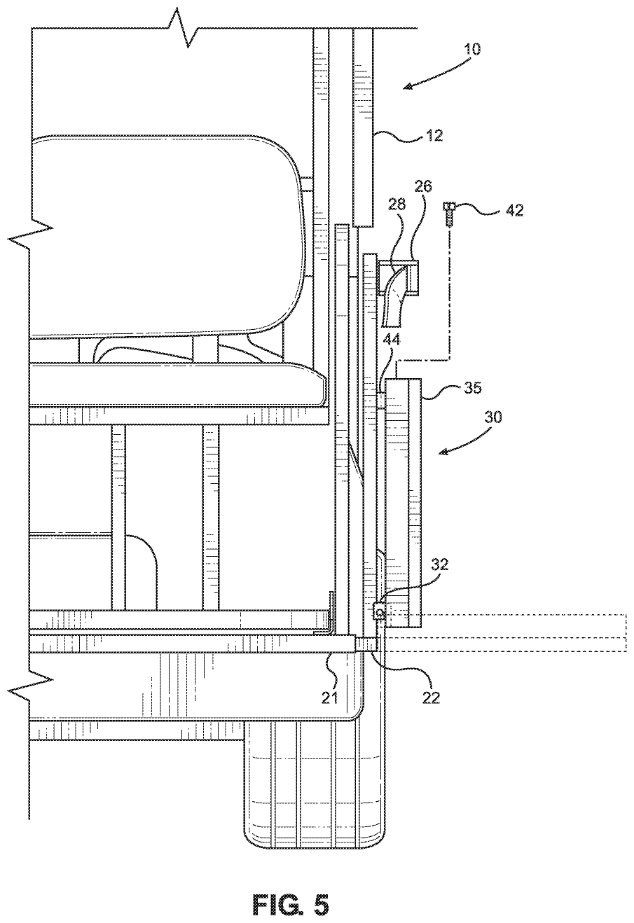

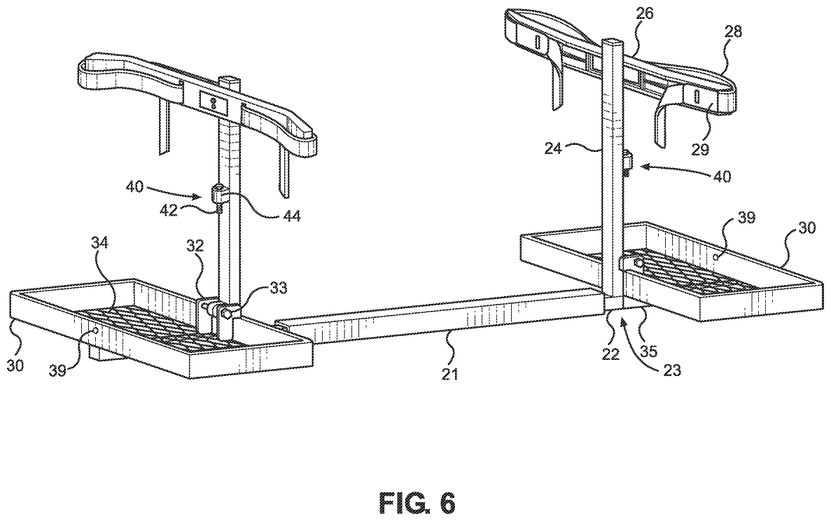

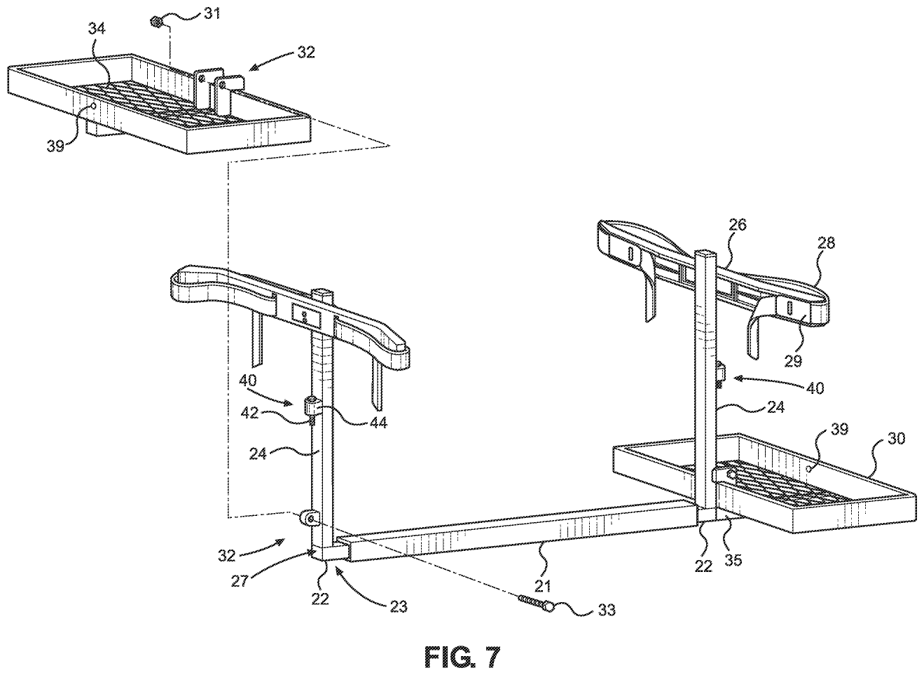

The lower frame member 22 may be a horizontal piece (horizontal referring to its orientation when the system is mounted on golf cart 10) as shown, for example, in FIG. 2. The lower frame member 22 may also comprise an expanded area, integrally formed or welded onto the frame member 22 to form surface 27. As best shown in FIGS. 7-9, surface 27 is a portion of the frame 23 upon which support tube 35 rests when the lower support member 30 is in its horizontal (first) position, in which it is suited for supporting one or more golf bags 50. FIGS. 5-6 illustrate how the lower frame member 22 supports lower support member 30 in the first, horizontal position.

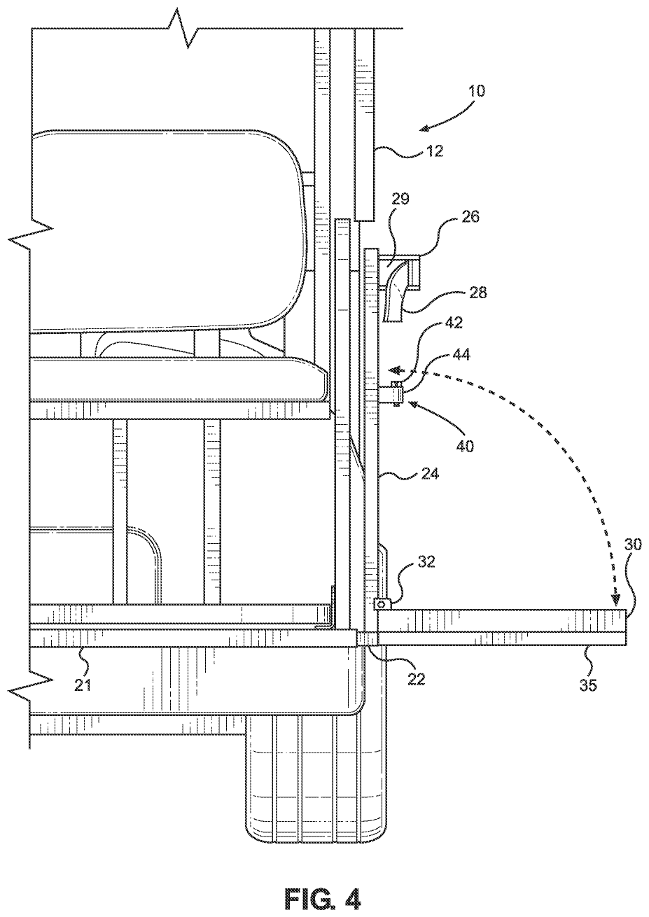

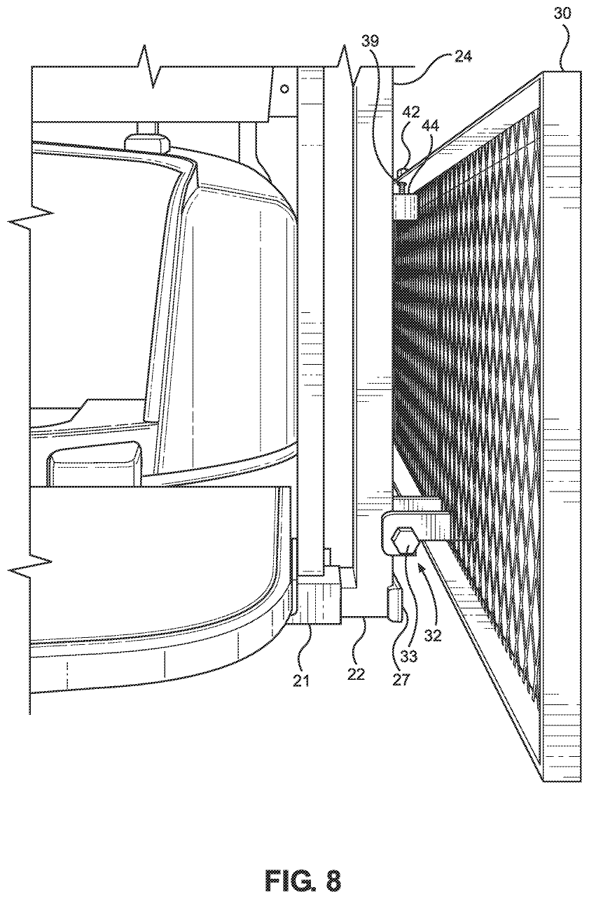

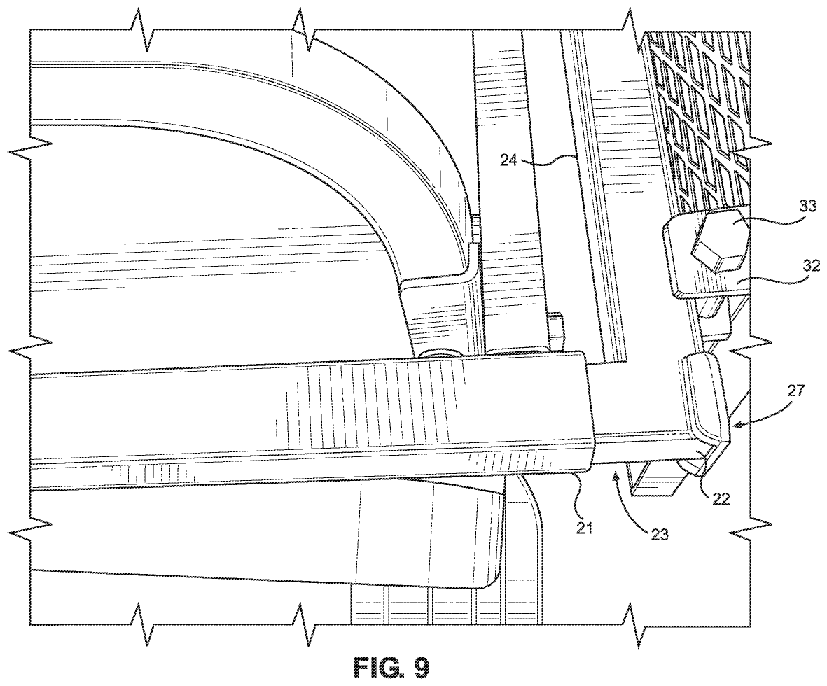

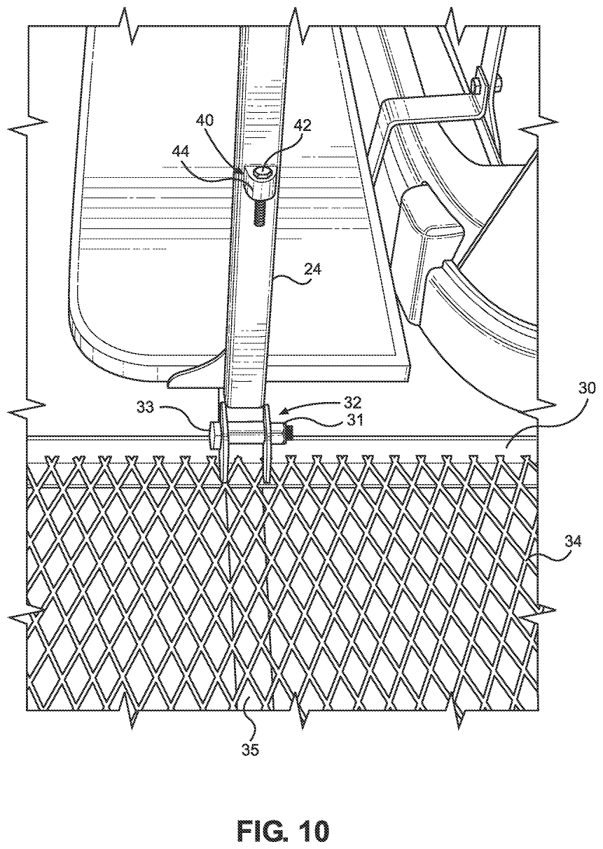

On the upper frame member 24, a hinge 32 may be used to pivotally attach 26 the lower support member 30 to the frame 23. Hinge 32 may comprise a stationary bracket or tube welded or attached to the upper frame member 24. A bolt 33 and nut 31 (as shown in FIG. 7) may pass through the bracket and hinge flanges on the lower support member 30 to form hinge 32. As shown in FIGS. 8-9, the hinge flanges may be relatively flat plates secured on lower support member 22, with a hole for bolt 33 to pass through. In the second position, in which the lower support member 30 is substantially vertical, the lower support member 30 is held in position by lock 40, which may be comprised of bracket 44 and a locking member, such as a bolt or pin 42 that fits through the bracket 44 and a hole 39 in the frame or a part of lower support member 30. As also shown in FIGS. 4-8 and 10, the bracket 44 of lock 40 may be secured to the upper frame member 24, or may be integrally formed as part of the upper frame member 24.

The rack 20 may also include a cross piece 26 mounted on the upper frame member 24, the cross piece 26 adapted to secure an upper portion of a golf bag 50 in the rack 20. The rack 20 further includes a lower support member 30 that can be pivotally mounted on the frame 23, for example, on upper frame member 24, wherein the lower support member 30 is pivotable between a first position and a second position.

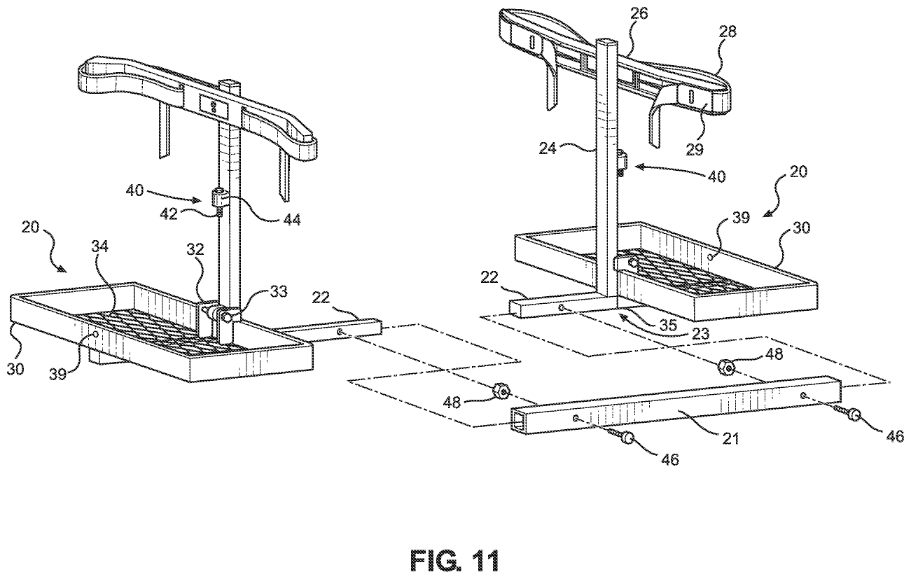

A golf bag holding system, as shown for example in FIGS. 7 and 11, may comprise two golf bag racks 20 permanently or removably attached at each end of a transverse mount 21. Each rack 20 comprises a frame 23, which is in turn comprised of a lower frame member 22 and an upper frame member 24. This entire assembly can be mounted securely on a golf cart 10, and may thus hold four or more golf bags 50.

As shown in the figures, and especially in FIG. 7, each upper frame member 24 may have a horizontal cross piece 26 firmly attached to it. The cross piece 26 is adapted to secure an upper portion of any golf bag being used. For example, one or more golf bags 50 can be secured to the rack 20 by the cross piece 26, and held to the cross piece 26 by a strap 28, which is tightened and secured with a buckle 29, as shown for example in FIG. 1.

One or both racks 20 can be removably attached to transverse mount 21, as shown in FIG. 11. Making the racks removable allows the cart to be used without racks blocking access to any area of the cart 10, if desired. As shown, the lower frame members 22 of racks 20 can be removably attached to the transverse mount 21 by a bolt 46 and a nut 48, although other fasteners, such as pins or snap rings, may be used. Mounting the racks with removable fasteners or means allows a cart 10 to be used without racks 20 in place to impede or block any part of the cart 10.

### C. Lower Support Member.

As shown in FIGS. 4 and 5, a lower support member 30 is pivotally attached to the frame 23. The pivotal attachment may comprise a hinge 32 formed by a bolt 33 as a pivot member that passes through a bracket 44 secured on the upper frame member 24, and hinge members on the lower support member 30.

Each lower support member 30 may comprise a basket, having a substantially flat portion that is sized and shaped to support one or more golf bags 50. The lower support member 30 may be made of various materials, such as metal, composite, plastic, etc. In one example, the lower support member 30 may comprise an expanded metal support surface 34 (which may comprise the substantially flat portion), angled metal side pieces, and a support tube 35, designed to rest against lower frame member 22 when in the first position. Together, these components provide a rigid assembly. In addition to a metal assembly, the lower support member 30 could be made of other materials, such as composites or molded plastic.

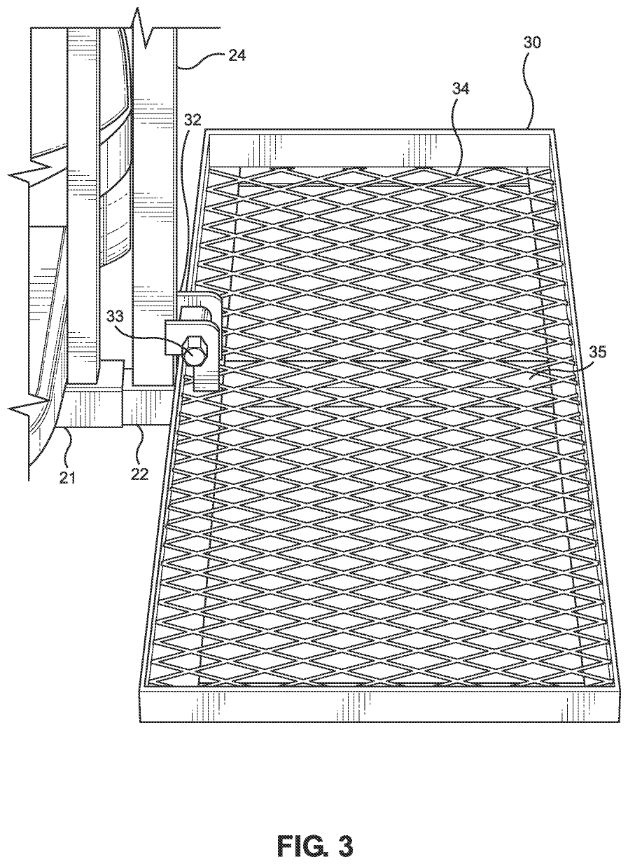

The lower support member 30 may be pivoted between a first position and a second position. The lower support member is substantially horizontal in the first position, and substantially vertical in the second position. The lower support member is shown in the first position in FIG. 3, and is shown in the second, substantially horizontal position in FIGS. 5 and 9. FIG. 4 illustrates how the lower support member 30 can be pivoted between the two positions, as indicated by the dotted line and arrow.

When the lower support member 30 is substantially horizontal, it can support one, two, or more golf bags 50, as shown for example in FIG. 1. When it is not in use, the lower support member 30 can be folded up and out of the way in a second, substantially vertical position. When the lower support member 30 is substantially horizontal, it is close enough to horizontal such that it can adequately support a golf bag. Similarly, when the lower support member 30 is substantially vertical, it is folded up and out of the way sufficiently that it does not create an obstacle to persons or objects moving near the cart. Further, when the lower support member 30 is in the second position, it is generally aligned with the upper frame member 24, as shown in FIG. 5. In addition to folding out of the way, if the racks 20 are removably attached as shown in FIG. 11, one or both racks 20 can be removed from transverse mount 21, which typically remains mounted on the cart 10.

As noted previously, the lower support member 30 can be held in the first position due to the support tube 35 resting against a part of lower frame member 22, such as surface 27, which prevents rotation about hinge 32 beyond the horizontal position. This is shown, for example, in FIG. 7, and support surface 27 is shown in more detail in FIG. 9. As best shown in FIGS. 4-5 and 8, in the second position, in which the lower support member 30 is substantially vertical, the lower support member 30 is held in position by lock 40, which may be comprised of bracket 44 and a locking member, such as a bolt or pin 42 that fits through the bracket 44 and a hole 39 (see, e.g., FIGS. 6-7) in the lower support member 30.

As shown in FIG. 1, the lower support member 30 is adapted to support one or more golf bags 50 in a position adjacent to the side 12, 14 of the golf cart 10 when the lower support member 30 is in the first position. The lower support member 30 can be folded up and out of the way when not in use. In this folded, second position, the lower support member 30 is oriented along the upper frame member 24. In some example embodiments, the lower support member 30 rests on a support surface 27 of the lower frame member 22 when the lower support member 30 is in the first position, wherein the lower frame member 22 supports the lower support member 30 by limiting its rotation.

FIGS. 2 and 4 and 7 show the lower support member 30 resting against lower frame member 22, while FIGS. 8 and 9 show support surface 27 in greater detail. Support surface 27 may be formed of a separate piece attached or welded onto lower frame member 22, or it may simply be comprised by the end of the horizontal portion of lower frame member 22. As shown in FIG. 7, the lower support member 30 may include a support tube 35 that adds rigidity to the lower support member 30. The support tube 35 may be a transverse, central element that rests on support surface 27 of the lower frame member 22 to limit the rotation of lower support member 30. This “in use” position is shown throughout the figures, and especially in FIG. 6.

### D. Operation of Preferred Embodiment.

In use, the system may be used to carry four or more sets of golf clubs on a four-seat golf cart, as shown for example in FIG. 1. As best shown in FIGS. 1 and 2, the system, which may comprise two golf bag racks 20 on each side of a golf cart 10, allows full use and access to the rear seat of the golf cart 10, which is feature that is not present in other racks. Other systems result in golf bags being mounted along the rear of a golf cart, such that a rear seat or rear portion of the cart is not usable or accessible from the back side.

The racks 20 can be added to an existing cart by welding or attaching a transverse mount 21 to existing brackets or frame components on the golf cart, as shown in FIGS. 4-5, for example. The other frame members can be either removably or permanently attached to the transverse mount 21. For example, as shown in FIG. 11, lower frame members 22 of racks 20 can be removably attached to the transverse mount 21 by bolt 46 and nut 48, although other fasteners, such as pins or snap rings, may be used. Mounting the racks with removable fasteners or means allows a cart 10 to be used without racks 20 in place to impede or block any part of the cart 10.

Frame members 22 of racks 20 may also be permanently attached to transverse mount 21 by welding, adhesives, or other means. Alternatively, the lower or upper frame members 22 and 24 could be mounted directly onto the frame or other elements of a golf cart 10. The system could also be modified so that each rack 20 can carry more than two bags. For example, the lower support member 30 could be made longer, so that three bags, rather than two, could be supported. The cross piece 26 and strap 28 would also be modified in such case, to match the number of bags that could be held by lower support member 30.

The frame 23 can be fabricated by welding pieces of square tubing together to form lower frame member 22 and upper frame member 24, although other techniques are possible as well, especially if the system is not made of metal. For example, the frame could be a molded composite part. Once the frame is constructed, the other components, such as the cross piece 26, bracket 44, support surface 27, and the hinge bracket, can be welded or attached to the frame 23, as best shown in FIG. 7. The basket that comprises the lower support member 30 may be made from expanded metal, composites, etc., to form a support surface 34, which may be substantially flat as shown in the figures.

Because the lower support member 30 is pivotally attached to the frame 23, it can be pivoted between a first position and a second position. The lower support member is substantially horizontal in the first position, and substantially vertical in the second position. The lower support member is shown in the first position in FIG. 3, and is shown in the second, substantially horizontal position in FIGS. 5 and 9. FIG. 4 illustrates how the lower support member 30 can be pivoted between the two positions, as indicated by the dotted line and arrow.

The first, substantially horizontal position is the “in-use” position, wherein the lower support member can support golf bags, as shown for example in FIG. 1. When a rack on either side is not in use, the lower support member 30 can be folded up and out of the way in a second, substantially vertical position. When the lower support member 30 is in the second position, it is generally positioned alongside the upper frame member 24, as shown in FIG. 5.

In the second position, in which the lower support member 30 is substantially vertical, the lower support member 30 is held in position by lock 40, which may be comprised of bracket 44 and a locking member, such as a bolt or pin 42 that fits through the bracket 44 and a hole 39 (see, e.g., FIGS. 6-7) in the lower support member 30. When the lower support member 30 is folded up, as shown in FIG. 4, hole 39 in a frame member lines up with a hole in bracket 44, and a bolt or pin 42 is inserted through both holes, thus removably locking the lower support member 30 in the vertical, second position. This action is shown in FIG. 5.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

What is claimed is:

1. A golf bag rack for use with a golf cart, comprising:
a frame comprising a lower frame member and an upper frame member, wherein the frame is mountable on a side of the golf cart;
a cross piece mounted on the upper frame member, the cross piece adapted to secure an upper portion of a golf bag; and
a lower support member pivotally mounted on the frame, wherein the lower support member is pivotable between a first position and a second position;
wherein the lower support member is adapted to support the golf bag in a position adjacent to the side of the golf cart when the lower support member is in the first position; and
wherein the lower support member is oriented along the upper frame member in the second position.

2. The golf bag rack of claim 1, wherein the lower support member is substantially vertical in the second position.

3. The golf bag rack of claim 1, wherein the lower support member comprises a basket.

4. The golf bag rack of claim 1, wherein the lower support member is mounted on the frame with a hinge.

5. The golf bag rack of claim 1, wherein the lower support member is adapted to be locked in the second position with a locking member.

6. The golf bag rack of claim 1, wherein the lower support member rests on a portion of the lower frame member when the lower support member is in the first position, wherein the lower frame member supports the lower support member by limiting its rotation.

7. The golf bag rack of claim 6, wherein the lower support member is substantially horizontal in the first position.

8. The golf bag rack of claim 1, wherein the lower support member is substantially horizontal in the first position.

9. The golf bag rack of claim 1, wherein the lower support member comprises a substantially flat portion which is adapted to support the golf bag.

10. The golf bag rack of claim 1, wherein the lower frame member is mountable on the golf cart by a transverse mount attachable to the golf cart.

11. The golf bag rack of claim 1, wherein the golf bag rack is adapted to hold two golf bags, wherein the lower support member is adapted to support two golf bags.

12. The golf bag rack of claim 1, further comprising a strap attached to the cross piece, wherein the strap is adapted to hold the upper portion of the golf bag against the cross piece.

13. A golf bag holding system for use with a golf cart, comprising:
a transverse mount adapted for mounting on the golf cart; and
two golf bag racks attachable to the transverse mount at opposite ends of the transverse mount, each golf bag rack comprising:
a frame comprising a lower frame member and an upper frame member, wherein the frame is removably attachable to the transverse mount;
a cross piece mounted on the upper frame member, the cross piece adapted to secure an upper portion of a golf bag; and
a lower support member pivotally mounted on the frame, wherein the lower support member is pivotable between a first position and a second position;
wherein the lower support member is adapted to support the golf bag in a position adjacent to a side of the golf cart when the lower support member is in the first position; and
wherein the lower support member is oriented along the upper frame member in the second position.

14. The golf bag holding system of claim 13, wherein the lower support member of each golf bag rack is substantially vertical in the second position.

15. The golf bag holding system of claim 13, wherein the lower support member of each golf bag rack is mounted on the upper frame member with a hinge.

16. The golf bag holding system of claim 13, wherein the lower support member of each golf bag rack is adapted to be locked in the second position with a locking member.

17. The golf bag holding system of claim 13, wherein the lower support member of each golf bag rack rests on a portion of each lower frame member when the lower support member is in the first position, wherein each lower frame member supports the lower support member by limiting its rotation.

18. The golf bag holding system of claim 13, wherein the lower support member of each golf bag rack is substantially horizontal in the first position.

19. The golf bag holding system of claim 13, wherein the lower support member of each golf bag rack comprises a substantially flat portion which is adapted to support each golf bag.

20. A golf bag rack for use with a golf cart, comprising:
a frame comprising a lower frame member and an upper frame member;
wherein the frame is mountable on a side of the golf cart;
a cross piece mounted on the upper frame member, the cross piece adapted to secure an upper portion of two golf bags; and
a lower support member comprising a basket having a substantially flat portion and being pivotally mounted on the upper frame member with a hinge, wherein the lower support member is pivotable between a first position and a second position;
wherein the substantially flat portion of the lower support member is adapted to support the two golf bags in a position adjacent to the side of the golf cart when the lower support member is in the first position;
wherein the lower frame member supports the lower support member by limiting its rotation; and
wherein the lower support member is adapted to be locked in a substantially vertical position and is oriented along the upper frame member in the second position.
